(19) United States
(12) Patent Application Publication
(10) Pub. No.: US 2012/0034154 A1
(43) Pub. Date: Feb. 9, 2012

(54) PRODUCTION OF HYDROGEN THROUGH OXIDATION OF METAL SULFIDES

(75) Inventors: Lawrence F. McHugh, North Andover, MA (US); Leonid Shekhter, Ashland, MA (US)

(73) Assignee: Orchard Material Technology LLC, North Andover, MA (US)

(21) Appl. No.: 13/176,268

(22) Filed: Jul. 5, 2011

Related U.S. Application Data
(63) Continuation-in-part of application No. 12/148,397, filed on Apr. 18, 2008.
(60) Provisional application No. 60/912,550, filed on Apr. 18, 2007.

(51) Int. Cl. C01B 3/06; C01B 17/50

(52) U.S. Cl. 423/539; 423/648.1

(57) ABSTRACT

Utilization of process and equipment for oxidation of metal sulfides, preferably two step metal sulfide oxidation reactions, and more preferably with looping back of second step oxide to the first step as an oxidizing agent, to generate sulfur dioxide and a useful metal or metal oxide, and react the sulfur dioxide with halogen (iodine or bromine) and water to produce sulfuric and halogen acid under moderate process conditions and equipment requirements and then dissociating the halogen acids (HI or HBr) to halogen and hydrogen as an overall environmentally and cost efficient and otherwise acceptable safe process for producing hydrogen and other useful products.

### CROSS REFERENCE TO RELATED APPLICATIONS

This application is a continuation-in-part of the co-pending U.S. patent application of Lawrence F. McHugh, Ser. No. 12/148,397 ('397) filed Apr. 18, 2008, which has priority from the provisional application Ser. No. 60/992,559 filed Apr. 18, 2007, and is of common assignment with this application, the contents of all of which are incorporated herein by reference as though set out at length herein.

### FIELD AND BACKGROUND OF THE INVENTION

The present invention relates to a new thermochemical cycle (process and apparatus) for producing hydrogen through coupling the hydrogen cycle by way of hydroiodic acid dissociation to another thermochemical cycle for producing high energy-metal oxidation reactions of industrial scale and providing the sulfur dioxide needed for reaction with halogen to generate the halogen acid and sulfuric acid. The invention also relates to such metal oxidation reactions per se for conversion of metal sulfides to metal oxides with capture of useful sulfur products. These cycles enable new use of known and new forms of certain metal oxidation reactions to produce energy in a way enabling breakthrough advances in hydrogen production, metal oxide, sulfur dioxide, sulfuric acid production, and combinations of such advances and related methods and apparatus.

The production of hydrogen from thermochemical cycles and hybrid cycles (thermochemical and thermoelectrolytic) is a technology that has been evolving over the past thirty years. Several sulfur based thermochemical cycles that incorporate sulfuric acid decomposition are now known in the art, such as a Sulfur-Iodine cycle developed at General Atomic Corporation in the 1970's and further developed later at Westinghouse Corporation to a so-called Westinghouse Sulfur Process (“WSP) as cited in the U.S. Pat. No. 7,261,874 by Lahoda and Task/Westinghouse. Such sulfur-iodine cycle and also sulfur-bromine cycles are by now well known. See also, B. Ildiz et al., “Efficiency of Hydrogen Production Systems Using Alternative Nuclear Energy Technologies,” 31 Int'l Jl. Of Hydrogen Energy 77-92 (2006) comparing WSP to other processes of hydrogen production and summarizing the advantages and disadvantages of such cycles. The WSP process uses thermal energy “waste heat” from a nuclear reactor for the decomposition of sulfuric acid or sulfur trioxide to oxygen, water and sulfur dioxide at elevated temperatures 800-1100° C. This step can be described by the following chemical reaction: H₂SO₄=>H₂O+SO₂(g)+0.5O₂(g). In the Sulfur-Iodine and Sulfur-Bromine processes sulfur dioxide reacts with water and iodine (or bromine) to form two immiscible liquids: sulfuric acid and hydroiodic acid (or hydrobromic acid). After separation of the two acids (generally by condensation) hydrogen is produced during the thermal decomposition of HI at 320° C. (or HBr at 750° C.) according to the reactions 2HI=>H₂(g)+I₂(g) and 2HBr=>H₂(g)+Br₂(g).

In the process described in the U.S. Pat. No. 7,261,874 sulfur dioxide released during the decomposition of sulfuric acid is absorbed in water at about room temperature and sent to an electrolyzer. The sulfur dioxide and water is then electrolyzed to hydrogen as a gas and sulfur trioxide.

As further described below the present invention recognizes and applies metal oxidation reactions to provide the energy for useful purposes and sulfur dioxide for a WSP or like reaction to produce hydrogen and preferably uses a metal sulfide looping oxidation process to supply high content sulfur dioxide flow, to either a sulfur-iodide or sulfur-bromide process of making hydrogen.

As a non-limiting illustrative example of state of the prior art, the technology of molybdenum trioxide production has traditionally been oxidizing roasting of molybdenite. (Zelikman A., Korshunov B., Metallurgy of Refractory Metals, Moscow, 1991, pp. 41-60). Typically, the roasting is carried out in a multiple hearth furnace. Molybdenite (MoS₂) slowly reacts with oxygen, eventually forming molybdenum trioxide, according to the sum reaction: MoS₂+3.5O₂=>MoO₃+2SO₂. This reaction is practically irreversible (ΔG° at 600° C.=−210 kcal/mol MoO₃) and is highly exothermic (ΔH at 600° C.=−253 kcal/mol). In practice on the top hearths (of a multi-hearth furnace) molybdenum trioxide reacts with molybdenite according to the reaction: MoS₂+6MoO₃=>7MoO₂+2SO₂ (ΔH° at 600°=4.8 kcal/mol). On the lower hearths molybdenum dioxide oxidizes to trioxide, according to the reaction: MoO₂+0.5O₂=>MoO₃ (ΔH at 600° C.=−37 kcal/mol). Due to the complexity of the process, it usually requires energy supply to some hearths, even though the sum reaction is highly exothermic. Typically, the SO₂ content in the off-gas varies from 1 to 4% (vol. pct.). Sulfur dioxide, obtained from molybdenite roasting, is typically utilized in an acid plant to make sulfuric acid. Oxidizing roasting in air makes the formation of nitrogen oxides unavoidable and it is detrimental from efficiency, economic and environmental perspectives

The practice of metal sulfide oxidation via two-step looping sulfide oxidation process is described by L. F. McHugh, R. Balliett and J. Mozolic in “The Sulfide Ore Looping Process: An Alternative to Current Roasting and Smelting Practice,” Journal of Metals (July 2008), pp. 84-87 and http://findarticles.com/p/articles/mi_qa5348/is_{—}200807/ai_n27998008 and in the PCT Patent Application publication WO 2008/130649 A1 of 30 Oct. 2008 of L. F. McHugh related to the '397 U.S. patent application cited above. In the first step the metal sulfide reacts with a metal oxide to produce a metal suboxide. In a subsequent step the suboxide is further oxidized raising the metal to a higher oxidation state. All or part of the oxide produced in the second step can be recycled to the first step to be reused as an oxidizing agent, indeed as the primary or sole oxidizing agent of the first step. The higher state oxide also can be recovered for other processing. See also, U.S. Pat. No. 4,552,749 granted Nov. 28, 1985 to L. F. McHugh, D. K. Huggins, M. T. Hepworth, and J. M. Laferty (“Process for the Production of Molybdenum Dioxide”) regarding an earlier process of molybdenite looping oxidation that failed in practice.

### SUMMARY OF THE INVENTION

We have discovered that for sulfides of certain metals, including, e.g. Mo, V, Pb, Co and certain combined metals, e.g. Fe/Cu the second step reaction (of the two step reaction described above) which is initially endothermic, can become highly exothermic in a certain range of temperatures in a controllable way and can be utilized for gains of energy efficiency, process efficiency and environmental benefits. This makes the looping oxidation process more attractive from the energy generation point. It also creates conditions for the chemical reaction in the first step to become self-propagating and can be used to generate new benefits, described below.

The thermodynamic analysis of the reaction between MoO₃ and MoS₂ is shown in Table 1, below.

TABLE 1
MoS₂ + 6MoO₃ = 7MoO₂ + 2SO₂(g)

| T | ΔH | ΔS | ΔG | |
|---|---|---|---|---|
| C. | kcal | cal/K | kcal | K |
| 100 | 5.382 | 68.333 | −20.117 | 6.07E+11 |
| 200 | 4.87 | 67.11 | −26.883 | 2.62E+12 |
| 300 | 4.422 | 66.251 | −33.55 | 6.22E+12 |
| 400 | 3.923 | 65.451 | −40.135 | 1.08E+13 |
| 500 | 3.299 | 64.589 | −46.638 | 1.53E+13 |
| 600 | 2.521 | 63.644 | −53.05 | 1.90E+13 |
| 700 | 1.583 | 62.629 | −59.364 | 2.15E+13 |
| 800 | 0.494 | 61.565 | −65.574 | 2.27E+13 |
| 900 | −72.66 | −6.356 | −65.204 | 1.41E+12 |
| 1000 | −75.62 | −8.779 | −64.443 | 1.16E+11 |
| 1100 | −78.156 | −10.699 | −63.465 | 1.26E+10 |
| 1200 | −80.246 | −12.17 | −62.318 | 1.76E+09 |
| 1300 | −81.862 | −13.233 | −61.045 | 3.03E+08 |
| 1400 | −82.978 | −13.923 | −59.684 | 6.26E+07 |
| 1500 | −83.566 | −14.265 | −58.272 | 1.52E+07 |

It can be seen from Table 1 that the reaction is thermodynamically favorable in a wide temperature range. At the temperatures typically used for the molybdenum sulfide roasting (500-600° C.), the reaction is slightly endothermic. It can also be seen from this Table that between 800 and 900° C. the reaction becomes exothermic. At the temperatures above 900° C. the reaction is highly exothermic and above 1000 deg. C. generates heat to the external environment rather than needing heat input. This fact creates a unique opportunity for using this reaction not only to produce molybdenum suboxide from molybdenum sulfide, and also serve as an energy generator to power other processes completely aside from production of molybdenum oxide. At 900° C. approximately 65 kcal/per mol of molybdenum sulfide can be converted into useful energy. This works similarly for other metal sulfides, including sulfides of V. Pb, Cu and combined metals such as Fe—Cu.

The state of the art molybdenite roasting in a conventional multiple hearth furnace process is carried out at relatively low temperatures to avoid sublimation of molybdenum trioxide produced. In the process of the present invention partial vaporization of molybdenum trioxide is very beneficial as it helps drastically improve kinetics of the process and increases desulfurization of molybdenite.

The plot of FIG. 1 shows that above 900° C. there is a tangible partial pressure of molybdenum-oxygen bearing species in equilibrium with molybdenum trioxide. An exothermic reaction, where one of the reagents is in the gaseous state, proceeds at higher rate and under certain conditions can become self-propagating. This process can also be carried out in a flash reactor. Other suitable equipment for this process may include a rotary kiln or fluidized bed furnace.

According to an aspect of the present invention, a breakthrough in production of hydrogen is realized to provide, via looping oxidation of metal sulfide, with the properly employed exotherm, a new source of sulfur dioxide reagent for certain thermochemical or thermolectrolytic reactions ending in hydrogen production. There are known hydrogen production processes but the world market may be poised for orders of magnitude increase through development of market and infrastructure for hydrogen fueling of cars, trucks and trains. Further, nuclear safety concerns will limit the will to expand nuclear energy production and adjunct thermochemical/thermoelectrolytic cycle processes.

Instead, per the present invention, an output with high percentage of sulfur dioxide, can be produced in combination with a looping metal sulfide oxidation process, preferably with exothermic enhancement as described herein, and the sulfur dioxide can be directly used in the Sulfur-Iodine or Sulfur-Bromine cycles or various other processes (e.g. WSP or like processes) that eventually generate hydrogen. This will eliminate the sulfuric acid decomposition step that requires energy supply by a nuclear plant or like heat generator (e.g. concentrated solar, geothermal, large scale industrial process with waste heat, etc. to the extent practical). Merchant grade or even laboratory grade metal oxide, sulfur dioxide and/or sulfuric acid can become other end products besides the target hydrogen product. Energy costs, capital costs and environmental issues can be reduced to an extraordinary degree by the new approach of the present invention. These reductions occur for various reasons including lower temperatures involved compared to WSP processing and the like in turn yielding lower equipment corrosion issues and lower cost equipment generally, lower risk of catastrophic failure, lower burdens of and risks of waste disposal and more efficient conversion of source materials and derating of source materials specifications.

Finally, the ability to meet the original purpose of metal sulfide oxidation (e.g., molybdenum sulfide oxidation) is greatly enhanced. The molybdenum dioxide (or other metal oxide) produced during the first step can be used for the molybdenum production. A significant amount of energy, capital investment and labor cost can be saved due to the elimination of hydrogen reduction of molybdenum trioxide.

Sulfides of other metals, can be oxidized with their higher oxides with energy release, as shown in Tables 2-6.

TABLE 2
6CuO + Cu₂S => 4Cu₂O + SO_{2(g)}

| T | ΔH | ΔS | ΔG | |
|---|---|---|---|---|
| ° C. | kcal | cal/K | kcal | K |
| 500.000 | 1.008 | 42.338 | −31.726 | 9.307E+008 |
| 600.000 | 0.065 | 41.191 | −35.900 | 9.696E+008 |
| 700.000 | −0.802 | 40.250 | −39.971 | 9.492E+008 |
| 800.000 | −1.595 | 39.474 | −43.956 | 8.963E+008 |
| 900.000 | −2.314 | 38.833 | −47.870 | 8.291E+008 |
| 1000.000 | −2.960 | 38.304 | −51.726 | 7.587E+008 |
| 1100.000 | −3.533 | 37.870 | −55.534 | 6.910E+008 |
| 1200.000 | −6.311 | 35.893 | −59.186 | 6.044E+008 |
| 1300.000 | −14.611 | 29.897 | −61.644 | 3.670E+008 |
| 1400.000 | −15.267 | 29.493 | −64.614 | 2.758E+008 |
| 1500.000 | −15.914 | 29.118 | −67.544 | 2.118E+008 |

TABLE 3
CuFeS₂ + 11CuO => 6Cu₂O + FeO + 2SO_{2(g)}

| T | ΔH | ΔS | ΔG | |
|---|---|---|---|---|
| ° C. | kcal | cal/K | kcal | K |
| 200.000 | 1.704 | 115.083 | −52.747 | 2.324E+024 |
| 300.000 | −0.239 | 111.359 | −64.064 | 2.695E+024 |
| 400.000 | −2.208 | 108.192 | −75.038 | 2.314E+024 |
| 500.000 | −4.198 | 105.436 | −85.716 | 1.705E+024 |
| 600.000 | −8.596 | 100.119 | −96.015 | 1.083E+024 |
| 700.000 | −12.179 | 96.224 | −105.820 | 5.846E+023 |
| 800.000 | −14.995 | 93.469 | −115.301 | 3.043E+023 |
| 900.000 | −17.711 | 91.048 | −124.524 | 1.585E+023 |
| 1000.000 | −20.330 | 88.906 | −133.520 | 8.357E+022 |
| 1100.000 | −22.850 | 87.000 | −142.313 | 4.492E+022 |
| 1200.000 | −25.276 | 85.294 | −150.927 | 2.470E+022 |

TABLE 4
10V₂O5 + V₂S₃ => 11V₂O₄ + 3SO_{2(g)}

| T | ΔH | ΔS | ΔG | |
|---|---|---|---|---|
| ° C. | kcal | cal/K | kcal | K |
| 500.000 | −103.382 | 189.618 | −249.985 | 4.681E+070 |
| 600.000 | −103.417 | 189.590 | −268.957 | 2.117E+067 |
| 700.000 | −258.000 | 27.519 | −284.780 | 9.146E+063 |
| 800.000 | −260.784 | 24.792 | −287.389 | 3.407E+058 |
| 900.000 | −263.037 | 22.781 | −289.763 | 9.667E+053 |
| 1000.000 | −264.792 | 21.343 | −291.965 | 1.327E+050 |
| 1100.000 | −266.074 | 20.371 | −294.047 | 6.371E+046 |
| 1200.000 | −266.900 | 19.789 | −296.052 | 8.405E+043 |
| 1300.000 | −267.284 | 19.535 | −298.015 | 2.542E+041 |
| 1400.000 | −267.236 | 19.563 | −299.968 | 1.533E+039 |
| 1500.000 | −266.763 | 19.837 | −301.936 | 1.653E+037 |

TABLE 5
3Pb₂O₃ + PbS => 7PbO + SO_{2(g)}

| T | ΔH | ΔS | ΔG | |
|---|---|---|---|---|
| C. | kcal | cal/K | kcal | K |
| 500.000 | −66.694 | 30.722 | −90.446 | 3.706E+025 |
| 600.000 | −68.788 | 28.176 | −93.390 | 2.385E+023 |
| 700.000 | −71.027 | 25.750 | −96.085 | 3.807E+021 |
| 800.000 | −73.409 | 23.421 | −98.543 | 1.176E+020 |
| 900.000 | −33.115 | 58.115 | −101.293 | 7.443E+018 |
| 1000.000 | −35.072 | 56.516 | −107.026 | 2.364E+018 |
| 1100.000 | −37.399 | 54.759 | −112.591 | 8.345E+017 |
| 1200.000 | −52.027 | 44.262 | −117.232 | 2.474E+017 |
| 1300.000 | −55.197 | 42.181 | −121.554 | 7.733E+016 |
| 1400.000 | −58.692 | 40.028 | −125.665 | 2.606E+016 |
| 1500.000 | −62.511 | 37.812 | −129.558 | 9.333E+015 |

An illustrative example of a useful endothermic oxidation reaction is the oxidation of cobalt sulfide (CoS) by cobalt oxide (Co₃O₄) to produce sulfur dioxide.

TABLE 6
CoS + 3Co₃O₄ <=> 10CoO + SO_{2(g)}

| T | ΔH | ΔS | ΔG | |
|---|---|---|---|---|
| ° C. | kcal | cal/K | kcal | K |
| 500.000 | 43.710 | 107.749 | −39.596 | 1.562E+011 |
| 600.000 | 43.670 | 107.705 | −50.373 | 4.068E+012 |
| 700.000 | 43.260 | 107.264 | −61.124 | 5.350E+013 |
| 800.000 | 42.518 | 106.541 | −71.816 | 4.234E+014 |
| 900.000 | 41.473 | 105.612 | −82.425 | 2.273E+015 |
| 1000.000 | 40.155 | 104.535 | −92.934 | 9.003E+015 |
| 1100.000 | 38.587 | 103.351 | −103.329 | 2.800E+016 |
| 1200.000 | 29.549 | 96.880 | −113.170 | 6.177E+016 |
| 1300.000 | 27.495 | 95.532 | −122.791 | 1.148E+017 |
| 1400.000 | 25.297 | 94.178 | −132.276 | 1.904E+017 |
| 1500.000 | 22.977 | 92.831 | −141.626 | 2.868E+017 |

According to a further aspect of the invention improvements in sulfur dioxide production (and downstream products such as sulfuric acid) is enhanced and at the same time the production of metal oxide is enhanced. The SO₂ concentration in the off-gas from the first step will be very high (more than 70%). The formation of sulfur dioxide takes place in an inert environment at a relatively low inert gas flow. This prevents or completely eliminates the formation of NOₓ compounds that usually occur during traditional molybdenum sulfide roasting and other conventional metal roasting. Such high SO₂ content creates a unique opportunity for its usage. The sulfide conversion from metal sulfide to metal oxide and sulfur dioxide via the looping oxidation process exemplified above yields separate high percent content of both outputs and substantially sequesters contaminants of the sulfide containing starting material to the first step thereby reducing associated clean up steps with economical and environmental benefit. The modification of the looping oxidation utilizing the now recognized exotherm enhances all such benefits.

The benefit of a new source of sulfur dioxide can also be realized without looping by producing a high recovery essentially uncontaminated sulfur dioxide through use of oxidation of certain metal sulfides (e.g. iron, cobalt or molybdenum sulfides) obtainable as ores or scrap with metal oxides (e.g. iron, cobalt or molybdenum oxides) obtainable as ores or scrap or as merchant products, with the extra cost if any, justifiable in the context of a new beneficial route to hydrogen production and other output products efficiently using the source materials and energy inputs and avoiding undue costs of waste product clean-up or environmentally secure disposition. As a whole the end products can be optimally used. For example, if the end products are sulfur dioxide and molybdenum oxide containing calcium oxide derived from the original sulfide/and/or oxide inputs the molybdenum oxide can be used as a ferro-molybdenum additive in steel making and residual contaminants are removed from the steel and do not materially alter the environment of costs of dealing with residues of the steel making process.

Other objects, features and advantages of the invention will be apparent form the following detailed description of preferred embodiments above taken in conjunction with the accompanying drawings, in which,

### BRIEF DESCRIPTION OF THE DRAWINGS

FIG. 1 is a plot of molar contents vs. temperature molybdenum trioxide;

FIG. 2A (Prior Art) is a schematic diagram of a state of the art by design production process using a nuclear reactor energy source; FIG. 2B (Prior Art) is a plot of energy, efficiency vs. temperature for processes of the same general class as the one shown in FIG. 2A; and FIG. 2C (Prior Art) is a schematic detail of a heat exchanger usable in such processes;

FIG. 3A is a block diagrams of a metal oxide two step looping oxidation process per preferred embodiments of the present invention using a looping oxidation process applied to produce hydrogen as well as a metal oxide and sulfur dioxide; FIG. 3B is a block diagram of the first part of such a process without the hydrogen production (3B), i.e. a sub-assembly useful on its own; and FIG. 3C is a block diagram of certain preferred embodiments of a metal oxidation process without looping applied to produce hydrogen as well as metal oxide and sulfur dioxide.

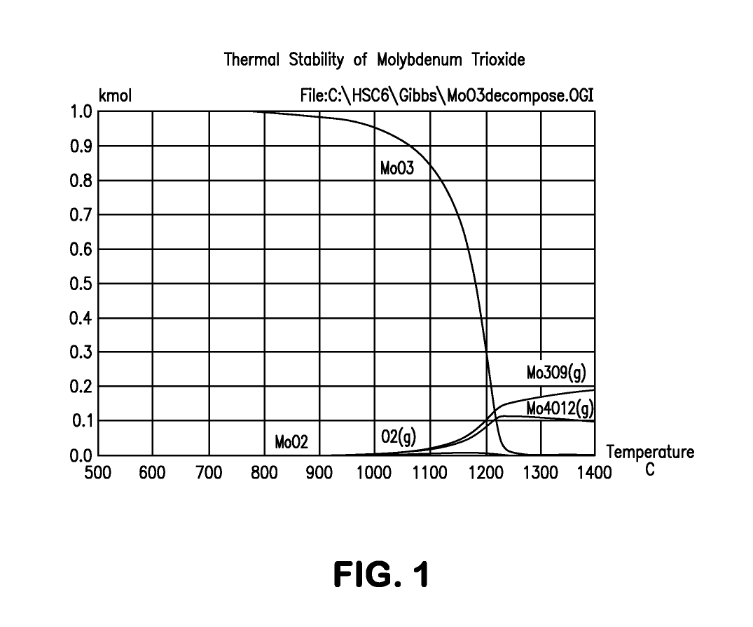

### DETAILED DESCRIPTION OF PREFERRED EMBODIMENTS

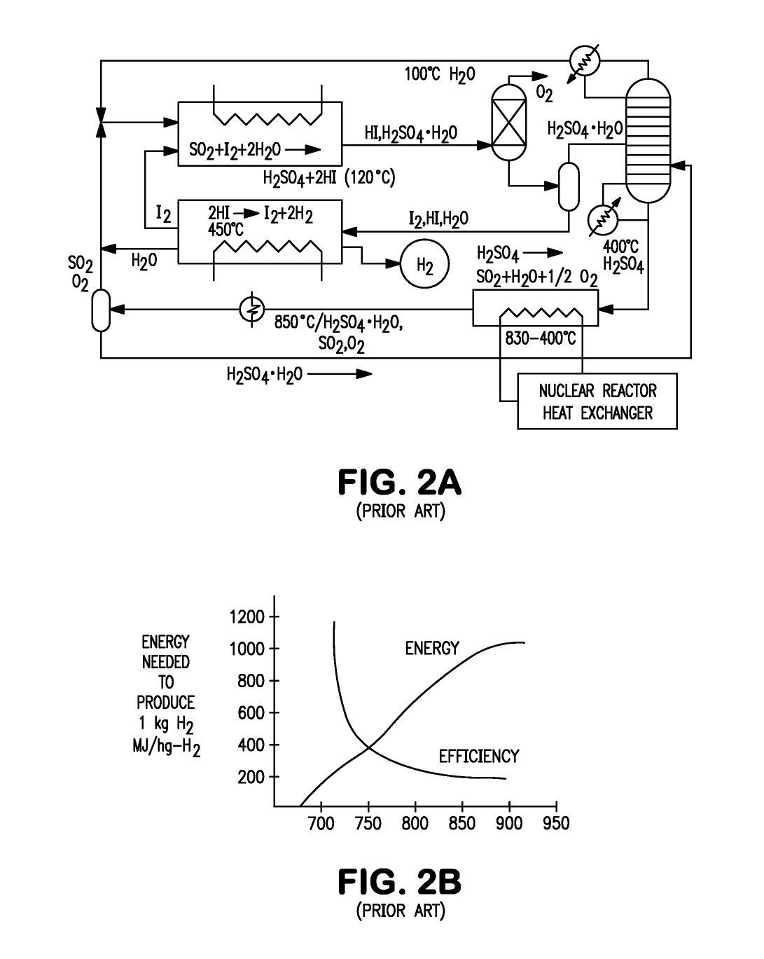

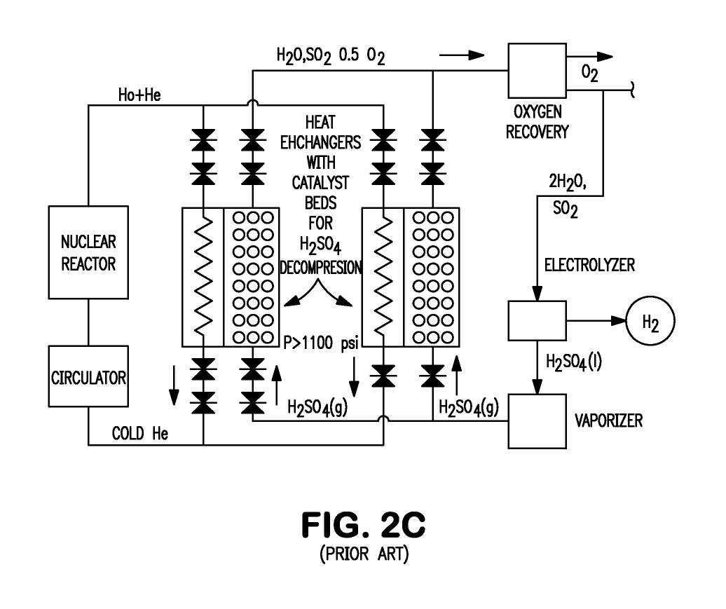

FIG. 2A is a schematic of a basic sulfur-iodine (SI) process using heat from a nuclear reactor to partially decompose sulfuric acid to water, sulfur dioxide and oxygen 830-900° C. The sulfur dioxide is reacted with iodine and water to produce HI, H₂SO₄ and H₂O. The HI and water are fed to a reactor maintained at 450° C. to produce iodine and the iodine is looped back to the latter sulfuric acid producing reactor and give off end product hydrogen. Apart from end product hydrogen (and oxygen if desired) the closed loop system has no effluents. It is described in the above cited Yildiz et al. article (at pp. 83-84) referring to a demonstration by the originator, General Atomics, and improvement by Japan Atomic Energy Research Institute. FIG. 2B herein is a projection of energy requirements and efficiency at various temperatures taken from FIG. 5 of the Yildiz et al. article. The limitations of the basic SI process are apparent.

FIG. 2C is a schematic diagram of prior art process of an enhanced hybrid (thermochemical electrolytic) WSP as described in U.S. published patent application of Lahoda and Mazzoccoli (Westinghouse), Ser. No. 11/054,235 filed Feb. 9, 2005 with Jun. 30, 2004 priority and published on Jan. 5, 2006 as US2006/0002845 A1 ('845). The process described in the '845 publication enhances prior sulfur based hydrogen production processes such as WSP by imposing pressure above 1000 psi (preferably 1450 psi, i.e. 10 Mega-Pascals, MPa) on the whole process ('845, par. [0019]). This increases process efficiency ('845, par. [0019]40025D and enables reduction of equipment corrosion (['845 pars. [0026]-[0035]). These and other advantages are summarized at '845, pars. [0036]-[40048].

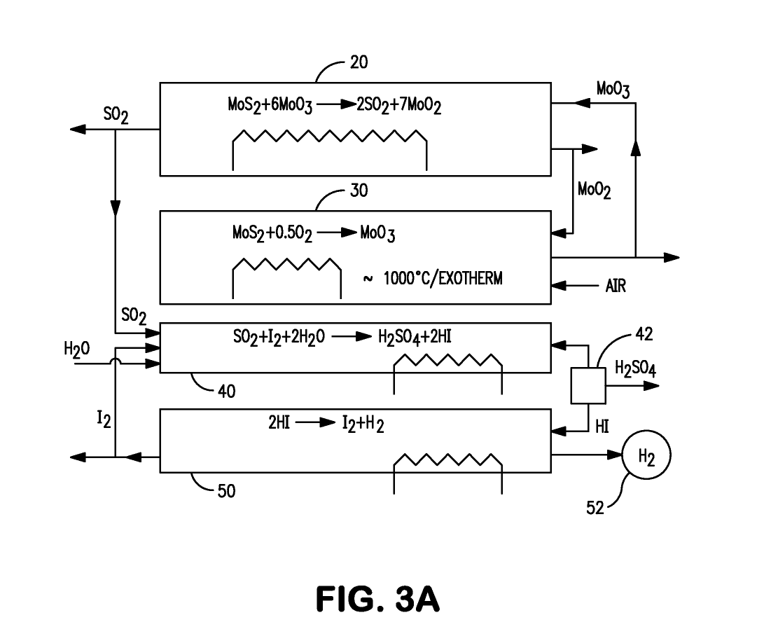

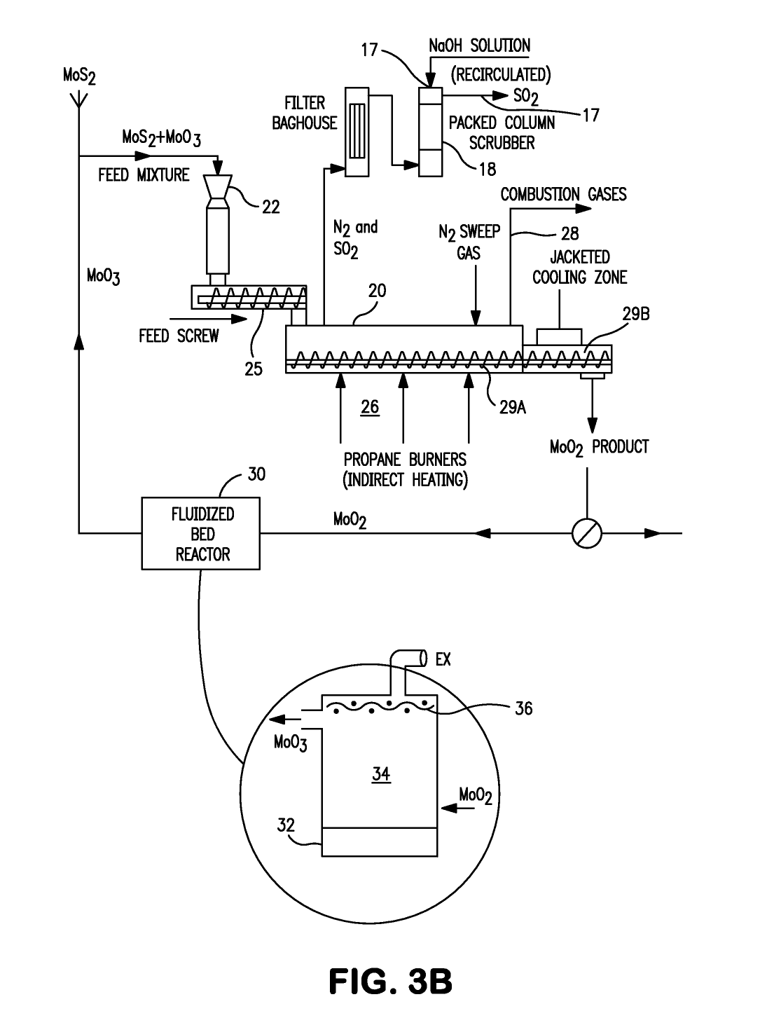

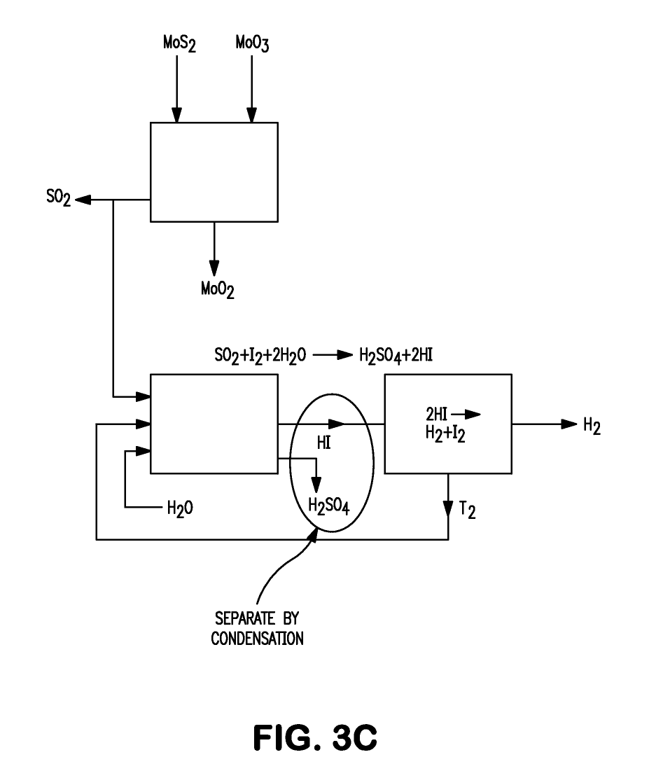

FIG. 3A shows schematically a process for hydrogen production per an embodiment of the present invention in which a first furnace reactor 20 (e.g., rotary kiln, tunnel kiln, fluidized bed, multi-hearth roaster) is used to convert an in-feed of a sulfide of a multi-valent metal, e.g. molybdenum sulfide. The sulfide is preferably provided in a particulated form sufficient to provide favorable kinetics but avoiding agglomeration at too fine particle sizes. It is preferably pre-blended (prior to reaction) with looped back molybdenum trioxide to optimize kinetics, reduce residual sulfur content and insure completion of reaction. It is oxidized to produce molybdenum dioxide (MoO₂) a lower oxide below higher available oxide of the metal (MoO₃) and sulfur dioxide in gas phase, in high percentage yields of separate outputs of 90 wgt-% or more even as high as 99.8 wgt-% conversion of the molybdenum content to MoO₂. Part of the MoO₂ is removed as a plant output and part is fed to a further furnace reactor 30 and oxidized using air or other oxygen containing reactant to convert the MoO2 to a higher oxide (MoO₃). The heating is done at a temperature level to initiate and use the exotherm as described above. The reactor 20 has conventional per se elements of a filter baghouse 19, packed column scrubber 18, with NaOH solution in-feed to obtain an output SO₂ gas product at 17. The operation of the furnaces is substantially continuous (fully continuous or intermittently cycled).

The portion of the overall process done in reactors 20 and 30 to produce molybdenum oxide and sulfur dioxide is valuable in its own right apart from usage to efficiently produce hydrogen.

A further more detailed showing of this example of furnace reactors 20, 30 with looping back oxidation is shown in FIG. 3B. In the furnace 20 is a feed hopper 22, a rotary conveyor 25, heat source 26 and an exhaust zone 28, with processing elements 29A, 29B to separate end products and providing MoO₂ to a fluidized bed reactor 30 which has a carrier fluid heating zone 32, a main fluidized bed 34 and an output filter 36. MoO₂(s) is oxidized in the reactor to MoO₃ which is looped back to furnace 20.

Referring again to FIG. 3A, all or part of the sulfur dioxide generated in furnace 20 is fed to a further reactor 40 and reacted there with iodine and water feeds to produce hydrosulfuric and hydroiodic acid (or with bromine in lieu of iodine feed to produce hydrobromic acid). The two acids can be separated in a condenser 42 and the hydroiodic acid (or hydrobromic acid) can be dissociated in a furnace reactor to produce hydrogen as an end product (taken up in a condenser 52) and iodine (or bromine) all or part of which is fed back to furnace 40 to maintain a substantially continuous process.

### Example

An example of a test version of the looping oxidation portion of the process to convert molybdenum oxide and sulfur dioxide was performed as follows: The equipment was essentially as in FIG. 3B. MoO₃ of the following composition, wgt-% (Mo-63.8, Cu-0.21, C-0.01, S-0.01, Pb-0.01, P-0.01) and MoS₂ of the following composition, wgt-% (Mo-59.5, Cu-0.05, Fe-0.14, Pb-0.01, Insol.-0.4, MoO₃-0.017, H₂O-0.0, Oil-0.02, MoS₂-99.20) were screened to minus 20 mesh and were mixed in a ratio of 11b (0.453 kg) MoS₂ to 5.94 lb (2.7 kg) MoO₃ to achieve a 10% excess stoichiometric amount of MoO₃. The material was fed into the 5-in. (127-mm) diameter 45 in. (1.14 m) long indirectly fired screw roaster (furnace 20). Nitrogen at a rate of 0.35 sft³/min (9.91/min) was fed counter currently as a sweep gas to remove the evolving SO₂. Any entrained fines in the sweep gas were filtered out in a downstream baghouse.

The feeding-in rate was metered at 10 lb/h with a separate feed screw 2 in. (51 mm) in diameter. 50 lb (22.7 kg) of the blend were charged at a time into the feed hopper. The temperature in the heated section of the furnace was controlled through propane flow to the burners, with the intention of gradually heating the material from the initial zone temperature of 500° C. to the final temperature of 700° C. Local overheating caused the material to agglomerate, thereby making the movement of material difficult. Periodically the screw had to be stopped, cooled down, and cleaned prior to further roasting. After exiting the heated section, the product was conveyed by the flutes to the water jacketed cooling section. Following the cooling section, the material was discharged into a nitrogen purged double valve, cam-locked receiving canister. Periodically, the canister was removed and the replacement canister was nitrogen purged and locked into place. The product continued to cool under a N₂ blanket within the removed canister.

Once cooled, the material was bagged and a representative sample was taken and analyzed. Overall, a 256 lb (116 kg) blend of MoS₂ and MoO₃ (10% excess MoO₃) was processed. The average sulfur content was 0.54%. The residual MoO₃ content was 6%. The calculated SO₂ content in the off-gas was in the range of 72-85%. The sulfur removal reached 98.6% capture of sulfur from the MoS₂ change.

The processing and equipment of FIGS. 3A, 3B are scalable to industrial needs to produce molybdenum oxide and sulfur dioxide. Also, all or part of the sulfur dioxide so produced can be fed to processing in a sulfur-iodine or sulfur-bromine process with prior art heat exchanges as shown, e.g. in FIGS. 2A, 2C, but with removal of the prior art sulfuric acid production and dissolution steps thereby effecting great enhancement of cost efficiencies and safety in a hydrogen production process.

The production of sulfur dioxide from metal ores or like sources as a feedstock processes of hydrogen production for the sulfur and/or other uses can also be achieved in processes that do not involve a looping oxidation as in the above described embodiments. Such further embodiments without looping include reactions of metal sulfides with externally provided metal oxides, e.g. ores or scrap materials with sufficiently high concentrations of the metal oxide or refined metal oxides produced by various known processes. Examples of such further embodiments are:

(a) reaction of iron sulfide with iron oxide:

FeS₂+5Fe₂O₃=>FeO+2SO₂

(b) reaction of iron sulfide with vanadium oxide:

FeS₂+5V₂O₅=>5V₂O₄₊FeO+2SO₂

(c) reaction of iron sulfide with molybdenum oxide:

FeS₂+5MoO₃=>FeO+5MoO₂+SO₂

(d) reaction of cobalt sulfide with iron oxide:

CoS+3Fe2O₃=>CoO+6FeO+SO₂

(e) molybdenum sulfide with molybdenum trioxide without looping:

MoS₂+6MoO₃=>7MoO₂+2SO₂

In all of these and other like reactions, the sulfide and oxide materials are provided as, or converted to particulate form, intermixed and heated to temperatures to drive the above reactions. In each case, the sulfur dioxide is obtained as a gas and of sufficient purity through such phase separation from other reaction inputs/outputs to be suitable for the sulfur based production of hydrogen as described above for previous embodiments. The sulfide oxidizing reactions produce sulfur dioxide and a useful oxide product that can be carried out in single or several steps reactions in any of the rotary kiln, multiple hearth furnace, fluidized bed reactor, flash reactor, plasma reactor or like apparatus, the temperature being controlled to minimize metal oxide vaporization.

Tables 7-1, through 7-4 below show the thermodynamic considerations and energy balances at temperatures from 600-1300° C. for embodiments (a)-(d) above.

TABLE 7-1
FeS2 + 5Fe2O3 = 11FeO + 2SO2(g)

| T | deltaH | deltaS | deltaG | |
|---|---|---|---|---|
| C. | kcal | cal/K | kcal | K = Pso2 |
| 600.000 | 171.396 | 140.779 | 48.475 | 7.339E−013 |
| 700.000 | 167.141 | 136.162 | 34.635 | 1.664E−008 |
| 800.000 | 166.320 | 135.349 | 21.070 | 5.113E−005 |
| 900.000 | 166.136 | 135.184 | 7.545 | 3.929E−002 |
| 1000.000 | 166.107 | 135.159 | −5.971 | 1.060E+001 |
| 1100.000 | 166.215 | 135.241 | −19.491 | 1.266E+003 |
| 1200.000 | 166.410 | 135.377 | −33.021 | 7.930E+004 |
| 1300.000 | 166.659 | 135.541 | −46.567 | 2.950E+006 |

TABLE 7-2
FeS2 + 5V2O5 = 5V2O4 + FeO + 2SO2(g)

| T | deltaH | deltaS | deltaG | |
|---|---|---|---|---|
| C. | kcal | cal/K | kcal | K |
| 600.000 | −3.514 | 124.271 | −112.021 | 1.100E+028 |
| 700.000 | −80.715 | 43.334 | −122.885 | 3.978E+027 |
| 800.000 | −81.967 | 42.106 | −127.153 | 7.892E+025 |
| 900.000 | −82.907 | 41.267 | −131.319 | 2.923E+024 |
| 1000.000 | −83.553 | 40.736 | −135.417 | 1.769E+023 |
| 1100.000 | −83.916 | 40.461 | −139.475 | 1.587E+022 |
| 1200.000 | −84.007 | 40.395 | −143.516 | 1.964E+021 |
| 1300.000 | −83.838 | 40.506 | −147.560 | 3.173E+020 |

TABLE 7-3
FeS2 + 5MoO3 = FeO + 5MoO2 + 2SO2(g)

| T | deltaH | deltaS | deltaG | |
|---|---|---|---|---|
| C. | kcal | cal/K | kcal | K |
| 600.000 | 19.543 | 77.208 | −47.871 | 9.620E+011 |
| 700.000 | 18.676 | 76.270 | −55.546 | 2.989E+012 |
| 800.000 | 17.664 | 75.280 | −63.124 | 7.184E+012 |
| 900.000 | −43.430 | 18.563 | −65.207 | 1.408E+012 |
| 1000.000 | −46.057 | 16.412 | −66.952 | 3.119E+011 |
| 1100.000 | −48.363 | 14.667 | −68.503 | 8.013E+010 |
| 1200.000 | −50.336 | 13.279 | −69.897 | 2.347E+010 |
| 1300.000 | −51.959 | 12.212 | −71.169 | 7.727E+009 |

TABLE 7-4
CoS + 3Fe2O3 = CoO + 6FeO + SO2(g)

| T | deltaH | deltaS | deltaG | |
|---|---|---|---|---|
| C. | kcal | cal/K | kcal | K |
| 600.000 | 97.530 | 71.285 | 35.287 | 1.469E−009 |
| 700.000 | 94.932 | 68.467 | 28.303 | 4.397E−007 |
| 800.000 | 94.379 | 67.920 | 21.491 | 4.198E−005 |
| 900.000 | 94.194 | 67.755 | 14.708 | 1.819E−003 |
| 1000.000 | 94.093 | 67.671 | 7.937 | 4.340E−002 |
| 1100.000 | 94.065 | 67.650 | 1.171 | 6.510E−001 |
| 1200.000 | 86.838 | 62.452 | −5.163 | 5.835E+000 |
| 1300.000 | 86.830 | 62.446 | −11.408 | 3.845E+001 |

Where ores, ore concentrates or other impure oxide sources are used as an oxidizing agent, there can be other components carried with it such as silica, calcium oxide, iron oxide, iron molybdenum. The sulfur dioxide is nevertheless a clean removal and the metal oxide end product can be separated as a useful product from the processing furnace end product by well known per se refining methods involving physical separation, hydrometallurgy and the like. In some applications ore refining can be minimal (e.g. pyrites, oxidation with MoO³ leading to a ferrous molybdenum raw material.

FIG. 3B shows schematically the operation of such further embodiments to produce hydrogen using, illustratively, the iron sulfide/molybdenum oxide reaction described above.

In “oxidizing” metal (M) sulfide in the first step of one or more process embodiments described above conditions can be controlled so that the product can be an oxide or a metal (M) or combination of metal M and its (sub)oxide. Preferrably, a second step oxidation reaction is done on the metal or (sub)oxide to create the oxidation agent for looping back to the first step as the sole or primary oxidizing agent therein. But the metal and/or oxide product of the first step can be useful end products (along with the sulfur dioxide end product) without any further steps.

The present invention is not limited to the examples of its practice described above. It will now be apparent to those skilled in the art that other embodiments, improvements, details, and uses can be made consistent with the letter and spirit of the foregoing disclosure and within the scope of this patent, which is limited only by the following claims, construed in accordance with the patent law, including the doctrine of equivalents.

What is claimed is:

1. A method of producing hydrogen through use of a metal oxidation process comprising, in combination, the steps of:
(a) providing a metal sulfide and oxidizing it in a first step to produce a sub-oxide of the metal or a metal and heating it in a further second step oxidation reaction to a higher oxide state and looping the higher metal oxide back to the first oxidation step as the sole or primary oxidizing agent thereby to produce a sulfur dioxide product,
(b) providing, in parallel to the metal oxidation reaction steps, a reaction of sulfur dioxide plus halogen (iodine or bromine) plus water to yield sulfuric acid and a halogen acid, and
(c) dissociating the halogen acid in a third step to yield hydrogen and halogen outputs.

2. The method of claim 1 wherein the metal oxide is copper oxide and metal sulfide precursor is copper sulfide.

3. The method of claim 1 wherein the metal oxide is copper oxide and metal sulfide precursor is vanadium sulfide.

4. The method of claim 1 wherein the metal oxide is copper oxide and metal sulfide precursor is copper sulfide.

5. The method of claim 1 wherein the metal oxide is molybdenum oxide and metal sulfide precursor is molybdenum sulfide.

6. The method of claim 1 wherein the metal oxide is copper oxide and iron oxide and the metal sulfide precursor is chalcogenite (CuFeS₂).

7. The method of claim 1 wherein the metal oxide is lead oxide and the metal sulfide precursor is lead sulfide.

8. The method of claim 1 wherein the metal oxide is cobalt oxide and the metal sulfide precursor is cobalt sulfide.

9. The method of claim 1 where the halogen acid is hydroiodic acid.

10. The method of claim 1 wherein the halogen acid is hydrobromide acid.

11. The method of claim 1 wherein the second step of oxidation to a higher state metal oxide has materials selection and process controls to enable an exothermic reaction to accelerate oxidation and further provide a useful energy output.

12. A method of production of metal oxide and sulfur dioxide through use a metal oxidation process comprising the steps of:
(a) providing a metal sulfide and heating it in an oxidation reaction with a metal oxide to produce a sulfur dioxide product and in a second step heating the oxide to a higher oxidation state agent, and
(b) looping the said higher state oxide back to the first step to serve as sole or primary oxidizing agent therein.

13. The method of claim 12 wherein the metal oxide is copper oxide and the metal sulfide precursor is copper sulfide.

14. The method of claim 12 wherein the metal oxide is vanadium oxide and the metal sulfide precursor is vanadium oxide vanadium sulfide.

15. The method of claim 12 wherein the metal oxide is copper oxide and the metal sulfide precursor is copper sulfide.

16. The method of claim 12 wherein the metal oxide is molybdenum oxide and the metal sulfide precursor is molybdenum sulfide.

17. The method of claim 12 wherein the metal oxide is copper oxide and iron oxide and the metal sulfide precursor is chalcogenite (CuFeS₂).

18. The method of claim 12 wherein the metal oxide is cobalt oxide and the metal sulfide precursor is cobalt sulfide.

19. The method of claim 12 wherein the metal oxide is lead oxide and the metal sulfide precursor is lead sulfide.

20. The method of claim 12 wherein conditions of the oxidation of metal sulfide are controlled through one or more of oxide-sulfide blending, particle sizes, pressure control and temperature control to maximize sulfur dioxide production from the sulfide and suppress oxide vapor phase formations.

21. A method of producing hydrogen through use of a metal oxidation process comprising the steps of:
(a) providing a metal sulfide and metal oxide mixture and heating them to produce a metal oxide product, and
(b) providing, in parallel to the metal oxidation reaction step, a reaction of sulfur dioxide plus halogen (iodine or bromine) plus water to yield sulfuric acid and a halogen acid, and
(c) dissociating the halogen acid to yield hydrogen and halogen outputs.

22. The method of claim 21 wherein the metal oxide is iron oxide and the metal sulfide is iron sulfide.

23. The method of claim 21 wherein the metal oxide is vanadium oxide and the metal sulfide is iron sulfide.

24. The method of claim 21 wherein the metal oxide is molybdenum oxide and the metal sulfide is iron sulfide.

25. The method of claim 21 wherein the metal oxide is iron oxide and metal sulfide is cobalt sulfide.

26. The method of claim 21 wherein the metal oxide is chromium oxide and the metal sulfide is iron sulfide.

27. The method of claim 21 wherein the metal oxide is molybdenum oxide and the metal sulfide is molybdenum sulfide.

28. The method of claim 21 where the halogen acid is hydroiodic acid.

29. The method of claim 21 wherein the halogen acid is hydrobromide acid.

30. The method of claim 21 wherein conditions of the oxidation of metal sulfide are controlled through one or more of oxide-sulfide blending, particle sizes, pressure control and temperature control to maximize sulfur dioxide production from the sulfide and suppress oxide vapor phase formations.
